(19) United States
(12) Patent Application Publication
(10) Pub. No.: US 2012/0323565 A1
(43) Pub. Date: Dec. 20, 2012

(54) METHOD AND APPARATUS FOR ANALYZING TEXT

(75) Inventors: Adam HILDRETH, Leeds (GB); Peter Maude, Leeds (GB)

(73) Assignee: Crisp Thinking Group Ltd., Leeds (GB)

(21) Appl. No.: 13/164,687

(22) Filed: Jun. 20, 2011

(51) Int. Cl. G06F 17/21

(52) U.S. Cl. 704/10

(57) ABSTRACT

An apparatus, a method, an applications programming interface and a computer program product for analyzing text. The text is transmitted between users of a text based network mediated system. The text is analyzed by intended word filter rule processing elements to determine a presence of a variation word of an intended word in the text. A method for creating the intended word filter rule processing elements is also disclosed.

### FIELD OF INVENTION

The field of the present invention relates to an apparatus, a method and a computer program product for determining variation words from intended words in a text.

### BACKGROUND OF INVENTION

A number of text based network mediated systems are known to exist, such as those provided by social networks (e.g. Facebook, Myspace and Bebo), massively media online games (MMOG), online instant messaging applications (e.g. Yahoo Messenger, MSN Messenger), ICQ applications and SMS based applications.

A use of the text based network mediated systems, by users of the text based network mediated systems has increased rapidly in recent years due to advancements in a technology of the text based network mediated systems. The text based network mediated systems allow users to chat and to exchange information in a text form with other users of the text based network mediated systems.

The text exchanged between users of the text based network mediated systems needs to be monitored and analyzed for a number of reasons.

The users of the text based network mediated systems may be engaged in chat which involves an inappropriate or illegal nature. The users of the text based network mediated systems may be engaged in activities such as spamming, bullying, child grooming, espionage terrorism, security and legal compliance.

The U.S. Children's Online Privacy Protection Act of 1998 (COPPA) Federal law (15 U.S.C. 36501). The COPPA applies to the online collection of personal information by persons or entities from children that are under the age of 13. The personal information can be a name, a home address, an email address and a telephone number or any other information that can be used to identify and/or contact the child. The COPPA governs the provision that a website operator must include in a privacy policy, when and how to seek verifiable consent from a parent or guardian and the responsibilities of the website operator to protect children's privacy and safety online

The COPPA provides for two different types of privacy policy. In a first type of privacy policy, the child is only allowed to use a text based network mediated system if a number of a credit card belonging the parent or the guardian is obtained. This can be difficult to achieve. In a second type of privacy policy, the parent or the guardian is merely informed by email that the child wishes to use the text based network mediated system. In the second type it is necessary to use a so-called white list of words and phrases that can be used on the text base network mediated system. However, as will be described below, establishment and curating of the white list is time-consuming and resource-intensive. For example, users of the text based network mediator system have tendency to use multiple variations of the same word when expressing themselves in chats. The known prior art systems require each of these variations to be added to the white list or otherwise the word will be blocked. Furthermore, new variations are being continuously developed and these have also to be added to the white list.

### BACKGROUND ART

A number of systems are known for monitoring the exchange of text between users of a text based network mediated system.

A first system uses what is referred to as canned chat. Canned chat allows users to exchange text with each other through a list of pre-approved words and phrases and nothing else. An example of canned chat is demonstrated in Disney's ToonTown SpeedChat (see for example, http://toontown.stratics.com/content/gameplay/speedchat/ viewed on the internet on 19 Dec. 2009). A disadvantage of the canned chat system is that there is a predominantly low level of engagement between the users which is due to the use of the pre-approved words and phrases. Users of the canned chat systems usually become disinterested very quickly as a result of the low level of engagement.

A further system uses what is called white list filtered chat. White list filtered chat relies on software tools to allow words and phrases that are present on a white list (i.e., an allowable words list) to be allowed in the text based network mediated system. The software tools will reject words and phrases that are not on the white list. A problem with white list filtered chat is that it punishes users for inaccurate spelling, which results in the white list expanding in size. The expansion of the size of the white list can however only go so far due to the time it takes to search through such lists using conventional computing technique 5. Secondly even white listed words can be used together to form bad phrases that should not permissible though the text based network mediated system.

A further system uses what is referred to as open filtered chat. Open filtered chat carries a problem that offensive text may be missed. The offensive text will therefore be allowed within the text based network mediated systems. The offensive text may violate user agreements between the users and the text based network mediated systems.

The prior art systems are ineffective and cumbersome to administer. The prior art systems require an enormous amount of administration by a moderator of the text based network mediated systems. The moderator may be required to frequently update the system, for example by extending the white lists. The moderator may also need to frequently update the list of forbidden words and phrases, i.e. the black lists.

The prior art systems are often hampered by inadequate processing ability as the number of users increases. As the number of users increases it often difficult for the systems to process an increase in the number of words and phrases. A problem often arises in that the technology of the prior art systems is ineffective to deal with certain rules which determine which words and phrases should be allowed within the text of the exchanged between users of the text based network mediated systems.

It will also be appreciated that the moderators are human and can therefore make mistakes. For example, the moderator may himself or herself spell a white list word incorrectly and therefore not allow correct spellings of the word to be allowed on the text base network mediated system. Similarly the moderator may spell the black list word incorrectly and therefore allow such forbidden (black-listed) words to be used on the text-based network mediated system.

A further issue with the current prior art systems is that new words, concepts and phrases are being continuously developed. For example, if a new television program is broadcast on one evening, it will be expected that the content of the television program will be discussed extensively on the text based network mediated system on the following day. The exact spelling of the name of the television program will not necessarily known and also the names of characters introduced into the television program may also be previously unknown. It can be therefore expected that users will spell the names incorrectly. Such incorrectly spelt or unknown words would not be allowed in the current prior art systems as the moderator will not be able to extend the white lists with all possible variations sufficiently quickly. This will lead to annoyance by the users of the text base mediated systems.

The aims of the present disclosure are to overcome the aforementioned problems and to fulfill regulations for the safety of users and brand reputation.

### SUMMARY OF INVENTION

The present disclosure teaches an apparatus for analyzing a text. The apparatus comprises at least one slave node that comprises of a plurality of intended word filter rules. The slave nodes and the intended word filter rules are selectable by a master node to process the text with the intended word filter rules.

The present disclosure teaches a method for analyzing a text. The method comprises a first step of receiving the text. The text is then processed with at least one intended word filter rule. The text is then analyzed to determine a presence of at least one variation word of an at least one intended word. It is then determined if the at least one variation word is a variation of the at least one intended word. The variation word which is a variation of the intended word is either blocked or displayed to the text.

The present disclosure teaches an intended word filter rule. The intended word filter rule comprises a plurality of variation words of an intended word. The variation words are at least one of an expression of the intended word devoid of at least one vowel, a misspelling of the intended word, a phonetic replacement of the intended word, a pluralization of the intended word, an alliteration of the intended word or a colloquial expression of intended word.

The present disclosure teaches a method for creating an intended word filter rule. The method comprises providing at least one intended word and creating a plurality of variation words of the at least one intended word. The plurality of variation words is at least one of an expression of the at least one intended word devoid of at least one vowel, a misspelling of the at least one intended word, a phonetic replacement of the at least one intended word, a pluralization of the at least intended word, an alliteration of the at least one intended word or a colloquial expression of the at least one intended word.

The present disclosure teaches a computer program product comprising a computer usable medium having control logic stored therein for causing a computer to analyze a text. The control logic comprises a first computer readable program code means for causing the computer to receive the text. The control logic comprises a second computer readable program code means for causing the computer to process the text with at least one intended word filter rule. The control logic comprises a third computer readable program code means for causing the computer to analyze the text to determine a presence of at least one variation word of an at least one intended word. The control logic comprises a fourth computer readable program means for causing the computer to determine if the at least one variation word is a variation of the at least one intended word. The control logic comprises a fifth computer readable program code means for causing the computer to one of displaying or blocking the variation word that is indicative of the at least one intended word to the text.

The present disclosure teaches an applications programming interface for analyzing text from a text based network mediated system. The applications programming interface comprises a first interface module and a second interface module. The first interface module is able to receive the text from the text based network mediated system and to send the text to a text analyzer. The text analyzer is adapted to analyze the text to determine a presence of an at least one variation word of an at least one intended word in the text. The text analyzer produces a result of analyzing the text. The second interface module is able to send the result of analyzing the text and the analyzed text to the text based network mediated system.

### BRIEF DESCRIPTION OF DRAWINGS

FIG. 1 shows an apparatus for an analysis of a text according to an aspect of the present disclosure.

FIG. 2 shows a method for an analysis of a text according to an aspect of the present disclosure.

FIG. 3 shows an application programming interface according to an aspect of the present disclosure.

FIG. 4 shows a further aspect of the method of a text.

### DETAILED DESCRIPTION OF INVENTION

For a complete understanding of the present disclosure and the advantages thereof, reference is made to the following detailed description taken in conjunction with the accompanying figures.

It should be appreciated that the various embodiments of the disclosure herein are merely illustrative of specific ways to make and use the features of the disclosure and do not therefore limit the scope of disclosure when taken into consideration with the appended claims and the following detailed description and the accompanying figures.

It should be realized that features from one aspect and embodiment of the disclosure will be apparent to those skilled in the art from a consideration of the specification or practice of the disclosure disclosed herein and these features can be combined with features from other aspects and embodiments of the disclosure.

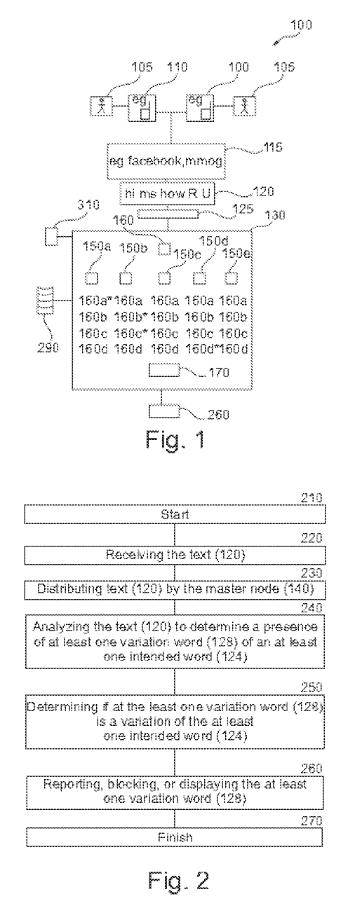

FIG. 1 shows an apparatus 100 according to an aspect of the present invention.

The apparatus 100 is able to analyze a text 120 which is posted or exchanged between one or more users 105 on a text based network mediated system 115.

The text based network mediated system 115 can be any application that allows the text 120 to be viewed and exchanged between the users 105. The text based network mediated system 115 can be for example a social online network such as Facebook, Bebo or MySpace, a massively media online game network (MMOG) and/or an online instant messaging application such as an ICQ based application, for example Yahoo Messenger or MSN Messenger, but is not limited thereto. The text based network mediated system 115 can also be for example a SMS based application of a mobile telephone. The text based network mediated system 115 can also be a bulletin board.

A number of the users 105 according to the present disclosure is be determined by a user capacity of the text based network mediated system 115, for example available bandwidth.

The users 105 post the text 120 to the text based network mediated system 115 by user devices 110, where the text 120 can be read by other users 105. The user devices 110 can include but are not limited to personal computers, mobile telephones with SMS functionality and personal digital assistants (PDA).

The user devices 110 are able to connect to the text based network mediated system 115 for example by conventional network connections systems known in the art that are compatible to operate with the text based network mediated system 115.

A text analyzer 130 is able to receive the text 120 between the users 105 from the text based network mediated system 115 and analyze the text 120. The text analyzer 130 captures the text 120 by a text capturer 125. The text capturer 125 takes the text 120 from the text based network mediated system 115 and provides the text 120 it to the text analyzer 130 for analysis. The text capturer 125 can also be integrated with the text analyzer 130 in some aspects of the disclosure. The text capturer 125 can be implemented as an application programming interface for passing text 120 between the text based network mediated system 115 and the text analyzer 130.

The text analyzer 130 and/or the text capturer 125 in an aspect of the present disclosure can be provided by a provider of the text based network mediated system 115. In a further aspect the text analyzer 130 and/or the text capturer 125 is provided by a third party (not shown).

The text analyzer 130 and/or the text capturer 125 can be embodied in the form of a hardware device. The text analyzer 130 can be embodied in the form of a computer program product such as a software.

The text analyzer 130 comprises in one aspect of the disclosure a master node 140 and a number of slave nodes 150a-e. Five slave nodes 150a-e are shown in FIG. 1, but this is not limiting of the present disclosure. Each of the number of slave node 150a-e contains a number of intended word filter rule processing elements 160a-e. The intended word filter rule processing elements 160a-e analyze the text 120 to determine if the text 120 contains variation words 128 of intended words 124, as described below.

Every one of the number of slave node 150a-e contains the same intended word filter rule processing elements 160a-d. The number of intended word filter rule processing elements 160a-d on every one of the number of slave node 150a-e is not limiting to the present disclosure.

The text analyzer 130 further includes a blacklist word filter rule 170. The blacklist word filter rule 170 analyzes the text 120 as described below.

The master node 140 accepts the text 120 from the text capturer 125 and distributes the text 120 to be analyzed to every one of the number of slave node 150a-e. It should be appreciated that the text 120 can include complete paragraphs of text, sentences, or single words present on the text based network mediated system 115.

It should be appreciated that the language of the text 120 is not limited by the present disclosure. The present disclosure can be used to analyze text 120 that is in a single language or even in a mixture of languages. That is to say that the intended word filter rule processing elements 160a-d and the backlist word filter rule 170 can analyze the text 120 in more than one language. The text analyzer 130 can for example distinguish between words that are swear words in one language and regular words in another language.

The settings of the intended word filter rule processing elements 160a-d and the blacklist word filter rule 170 can be determined and edited depending on the requirements of the operator of the text based network mediated chat system 115. It will be appreciated that a children's chat room will require a different set of vocabulary compared to a chat room discussing stock market prices for example.

The text 120 distributed to every one of the number of slave node 150a-e is the same text 120. Each one of the number of slave node 150a-e analyzes the text 120 with a different subset of the intended word filter rule processing elements 160a-d. The master node 140 instructs each one of the number of slave node 150a-e which intended word filter rule processing elements 160a-d to use to analyze the text 120.

For illustrative purposes, in FIG. 1 the slave node 150a analyzes the text 120 with intended word filter rule processing elements 160a as shown by an asterisk. The slave node 150b analyzes the text 120 with intended word filter rule processing elements 160b and 160c as shown by an asterisk. The slave node 150c is not used to analyze the text 120 The slave node 150d analyzes the text 120 with intended word filter rule processing elements 160d as shown by an asterisk. The slave node 150e is not used to analyze the text 120. It will be appreciated that in fact each one of the slave nodes 150a-e has a number of intended word filter rule processing elements 160a-d.

The distribution of the text 120 to every one of the number of slave nodes 150a-e and instructing each one of the number of slave node 150a-e which intended word filter rule processing elements 160a-d to use to analyze the text 120 by the master node 140 reduces the processing time taken to analyze the text 120. The text 120 is analyzed in parallel by the number of slave nodes 150a-e. The number of slave nodes 150a-e also incorporates redundancy. If any of the slave nodes 150a-e becomes inoperative, the analysis of the text 120 can be switched to a different salve node by the master controller 140.

A method 200 for an analysis of the text 120 according to an embodiment of the present disclosure is shown with reference to FIG. 2.

It should be appreciated that the text 120 can be analyzed in real time or in delayed time, for example when the text based network mediated system 115 is online or offline respectively.

The method starts in step 210.

In step 220 the text 120 is captured by the text capturer 125 from the text based network mediated system 115 and sent to the text analyzer 130 for analysis. In an aspect of the present disclosure the text 120 can be received by the text analyzer 130 when present on the text based network mediated system 115. In an alternative aspect the text 120 can be received by the text analyzer 130 before it is present on the text based network mediated system 115 i.e. when the text 120 is being input into the user device 110 by the users 105.

In an example of the present disclosure and as shown in FIG. 1 the text 120 is “hi m8 how R U”

In step 230 the text 120 “hi m8 how R U!” is distributed to every one of the number of slave nodes 150a-e by the master node 140. The master node 140 instructs each one of the number of slave nodes 150a-e which intended word filter rule processing elements 160a-d to use to analyze the text 120 “hi m8 how R U!”.

In step 240, the text 120 “hi m8 how R U!” is analyzed by the intended word filter rule processing elements 160a-d to determine a presence of at least one variation word 128 that is a variation of an intended word 124 in the text 120. The intended word filter rule processing elements 160a-d looks for variation words 128 as a variation of the intended word 124 in the text 120. In aspects of the present disclosure the variation word 128 is a text expression of the intended word 124 devoid of at least one vowel, a misspelling of the at least one intended word 124, a phonetic replacement of the at least one intended word 124, a pluralization of the at least one intended word 124, an alliteration of the at least one intended word 124 or a colloquial expression of the at least one intended word 124.

Therefore in the example of the present disclosure where a user 105 has inputted the text 120 as “hi m8 how R U” the variation word 128 “m8” could be an intended word 124 “mate”. The variation word 128 “R” could be an intended word 124 “are”. The variation word 128 “U” could be an intended word 124 “you”. The principle is described below in more detail

As a further non-limiting example if the text 120 contains any of the variation words 128 “schol”, “scool”, “scewl”, “schools” any one of these words would be recognized by the intended word filter rule processing elements 160a-d as variation words 128 of the intended word 124 “school”. The variation word 128 “schol” is a text expression of the intended word 124 “school” devoid of at least one vowel. The variation word 128 “scoot” is a text expression of the intended word 124 “school” as either a misspelling or a phonetic replacement of intended word 124 “school”. The variation word 128 “scewl” is a text expression of the intended word 124 “school” as a phonetic replacement of the intended word 124 “school”.

In a similar example if the text 120 contains any of the following variation words 128 “m8”, “mat”, “mayt”, “mates”, then any one of these words would be recognized by the intended word filter rule processing elements 160a-d as variation words 128 of the intended word 124 “mate”. The variation word 128 “m8” is a text expression of the intended word 124 “mate” as a phonetic replacement of the intended word 124 “mate”. The variation word 128 “mat” is a text expression of the intended word 124 “mate” devoid of at least one vowel of the intended word 124 “mate”. The variation word 128 “mayt” is a text expression of the intended word 124 “mate” as a colloquial expression of the intended word 124 “mate”.

In a non limiting example, if the intended word 124 is “basted”, then the intended word filter rule processing elements 160a-d will look for a variation word 128 which may be expressed as “barsted”, “bastid”. The variation word 128 “barsted” is a text expression of the intended word 124 “basted” as a misspelling of the intended word 124 “basted” or could be a phonetic replacement of the intended word 124 “basted”.

The intended word filter rule processing elements 160a-d determines various expressions of the intended word 124. The intended word filter rule processing elements 160a-d overcome problems where users 105 attempt to circumvent conventional white list and/or black list rule based filters known in the art. Furthermore the present disclosure allows text 120 to be expressed as users may speak in the real world. The intended word filter rule processing elements 160a-d do not penalize expression, urban type slang or misspellings of text 120 that may be blocked by conventional white list and/or black list rules known in the art. The intended word filter rule processing element 160a-d operates as a “smart” white list.

When it has been determined in step 250 that the variation word 128 in the text 120 is a variation of the intended word 124 this result is saved on a storage element 190 and the variation word 128 can displayed or blocked in the text 120 by a text filter 180. Furthermore when it has been determined in step 250 that the variation word 128 in the text 120 is a variation of the intended word 124 this result is allocated to a category and reported to the operator of the text based network mediated system 115. The categorization of the result is based on a number of factors which can be determined by the operator of the text based network mediated system 115. For example such categories could result in a banning of the user 105 for a particular length of time or a warning being issued to the user 105. It is up to the operator to decide the categories and the action resulting from the categorization.

The categorization of the results enables the operator of the text based network mediated system 115 to determine which user 105 is attempting to exchange inappropriate information and how many times such a user 105 is attempting to exchange inappropriate information. The categorization of the results further enables the operator of the text based network mediated system 115 to determine which variation words 128, users 105 are using on the text based network mediated system 115. A knowledge of the variation words 128 that the, users 105 are using on the text based network mediated system 115 enables the intended word filter rule processing element 60 to be updated taking into account the variation words 128 used.

The storage element 190 stores information such as which text 120 was analyzed and at which moment in time the text was analyzed. The time at which the text 120 is analyzed by a clock (not shown) which is operable with the text analyzer 130 and the text based network mediated system 115. The storage element 190 stores information as to which slave nodes 150 and intended word rules processing element 160 were used to analyze the text 120. The storage element 190 stores information as to which users 105 was responsible for posting the text 120 on the text based network mediated system 115. The information regarding the user 105 is derived by methods known in the art for tracking the user device 110 used by the user 105. For example where a user 105 is using the user device 110 in the form of a personal computer to post text 120, information regarding the user 105 is derived by determining an internet protocol (IP) address of the user device 110. For example where a user 105 is using the user device 110 in the form of a mobile telephone to post text 120 (by an SMS based application) information regarding the user 105 is derived by determining a mobile telephone number of the user device 110. The information regarding the user 105 can also be determined form a user name (i.e. login information) that the user 105 used to authenticate them with the text based network mediated system 115.

The results of the analysis of the text 120 can be used by the host of the text based network mediated system 115, a police officer or any other legal person who has an interest in the text 120 being transmitted between users 105.

In a further aspect of the present disclosure, once the text 120 has been analyzed with the intended word filter rule processing element 160a-d, the text 120 is analyzed with the blacklist word filter rule 170. The blacklist word filter rule 170 operates as a conventional black-list known in the art. The blacklist word filter rule 170 analyzes the text 120 for words and phrases that are present in the blacklist word filter rule 170. The blacklist word filter rule 170 will block words and phrases in the text 120 that are present in the blacklist word filter rule 170 from being displayed in the text 120. If it is determined that that variation word 128 in the text 120 is a variation of the intended word 124 and the intended word 124 is not on the blacklist word filter rule 170, then the variation word 128 is displayed in the text 120. The blacklist word filter rule 170 operates an as additional safety precaution for analyzing the text 120.

A further aspect of the present disclosure is the so-called ‘Grey list’ which allows the stopping of two good white list variations being used together to form a bad phrase. All variations of a given word, such as “green” (e.g. gr33n, gren) are linked to a grey list phrase analysis so if the phrase “Green People” needed to be stopped, then also gr33n p30pl3, green p30ple, green peeooopppplleeee etc., would be stopped.

The method 200 of the present disclosure can be executed in real time or in delayed time. That is to say where the users 105 are using the text based network mediated system 115 such as an online instant messaging application such as Yahoo Messenger or MSN Messenger, which is live, then the method will be executed as the text 120 is transmitted between the users 105 in real time.

It should be appreciated that the creation of the intended word filter rule processing element 160 depends on the needs of the text based network mediated system 115.

An intended word filter rule generator 310 creates the intended word filter rule processing element 160 from an intended word 124 to create a number of variation words 128. The intended word filter rule generator 310 can be a part of the text analyzer 130. The intended word filter rule generator 310 can be embodied in the form of a hardware device or a software device.

The variation words 128 in various aspects of the present disclosure is a text expression of the intended word 124 devoid of at least one vowel, a misspelling of the at least one intended word 124, a phonetic replacement of the at least one intended word 124, a pluralization of the at least one intended word 124, an alliteration of the at least one intended word 124 or a colloquial expression of the at least one intended word 124.

For example the intended word 124 are “school”, “cool”, “think”, “yes”, “realize”, “tomorrow”, “body” and “something”, then these words are entered into the intended word filter rule generator 310.

In the above example where the intended word 124 is “school” the following variation word 128 could be created: skewl—as phonetic replacement of the at least one intended word 124 “school”. Where the intended word 124 is “cool” the following variation word 128 could be created: kewl—as phonetic replacement of the at least one intended word 124 “cool”. Where the intended word 124 is “yes” the following variation word 128 could be created: yesss—as phonetic replacement of the at least one intended word 124 “yes”. Where the intended word 124 is “realize” the following variation word 128 could be created: realeyes—as phonetic replacement of the at least one intended word 124 “realize”. Where the intended word 124 is “tomorrow” the following variation words 128 could be created: 2mrw or tumrw—as phonetic replacement of the at least one intended word 124 “tomorrow”. Where the intended word 124 is “body” the following variation words 128 could be created: bodys and bodee—as a pluralization and phonetic replacement of the at least one intended word 124 “body”. Where the intended word 124 is “something” the following variation words 128 could be created: sumfink and sumfin—as a colloquial expression of the at least one intended word 124 “something”.

The intended word filter rule generator 310 allows a large number of intended word filter rules processing element 160 to be rapidly generated. Furthermore the intended word filter rule processing element 160 avoids the need for rules to be periodically administered which may be time consuming and prone to error if done manually.

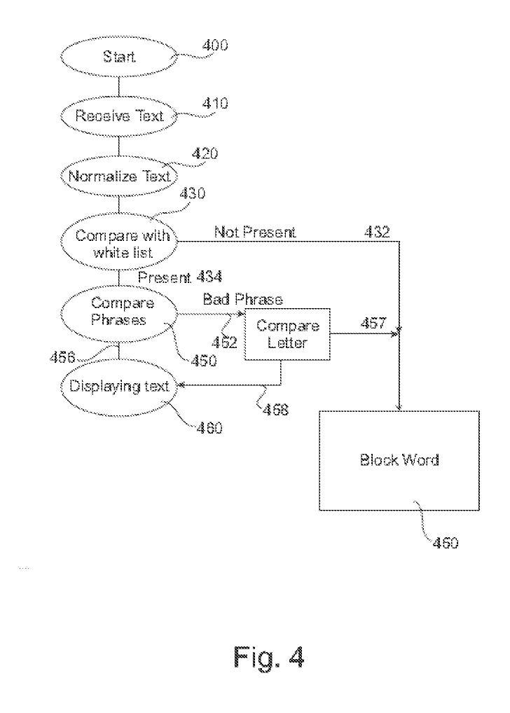

A further embodiment of the disclosure is shown in FIG. 4. The methods start in step 400. In step 410 the text 120 is captured by the text capture 125 from the text-base network mediated system 115 and send to the text analyzer 130 for analysis. As discussed above, the text 120 can be received by the text analyzer 130 when present on the text-based network mediated system 115. In an alternative aspect of the present disclosure the text 120 can be received by the text analyzer 130 before the text 120 is present on the text based network mediated system 115, i. e. when the text 120 is being input into the user device 110 by the users 105.

In step 420 the text is normalized. In this aspect of the invention each word in the text 120 is analyzed and reduced to a “normalized” word that is derived from and similar to the intended word 124. For example, in one aspect of the method a normalized word is derived from the word in the text 120 by removing letters in the word and/or by replacing letters in the word in order to generate the normalized word. The normalized word derived from the variation word in the text 120 can then be compared with the normalized word stored on the storage element 190.

An example of normalization of the words will illustrate this. Suppose that the word to be normalized is “thinking” The normalized word can be generated by removing all of the vowels in the word “thinking” Thus the normalized word would be “thnkg” It therefore does not matter if the word is spelt incorrectly with additional vowels to emphasize the word. Similarly if there are duplicate vowels in a word all of the vowels could be removed or, in the case of short words, all but one of the vowels could be removed. An example would be the word “cool”. In this case a normalized word with all of the vowels removed would be “cl”. This normalized word potentially has several meanings. It would therefore we sensible to reduce the four letter word “cool” only to the three letter word “col”. In this case the variation word “cooool” in the text 120 would be firstly normalized by moving all of the duplicate vowels to get “col” which is identical to the normalized word. Since the normalized word had only three letters it is acceptable and there is no need to remove further vowels.

The same example can be used in connection with the word “caallllll”. Removing all of the duplicate letters produces a normalized word “cal”. This example shows why it is important that, for small words, not all of the vowels are removed as the two consonant normalized word “cl” could be either cool or call.

In other words, the normalized word is derived from the variation word in the text and becomes the intended word 124. The normalized word is compared with the white list in step 430. In this embodiment of the invention that the white list comprises a list of normalized words generated as disclosed above. If the normalized word is not present in the white list than the word is blocked as in step 440 by choosing the path 432. On the other hand if the normalized word is present in the white list than path 434 is chosen and in step 450 phrases are compared.

The comparison of phrases in step 450 enables a blocking of a combination of words that are, as such, each acceptable. On the other hand the combination of the words leads to a phrase that might be unacceptable. An example of this could be the phrase “green people”. The step 420 of normalization leads to the normalized words “grn” and “ppl”. Neither of these two words is, as such, objectionable. However, the phrase “grn ppl” is the normalized phrase of the expression “green people” and is deemed to be unacceptable. Thus path 452 is chosen. On the other hand if the phrase is deemed acceptable (as the phrase does not appear on a black list) thus path 456 is chosen and in step 460 the text 120 is displayed. It will, of course, be appreciated that the text 120 is displayed not in the normalized version, but in the normal version.

On the other hand if in the step 450 or the comparison of the phrases, that phrase is initially identified then a letter comparison is carried out in step 454 in order to determine that the phrase is truly a bad phrase. An example would be the words “fish” and “it”. The normalized words are “fsh” and “it” (it will be appreciated that “it” is so short that the normalized word is identical to the real word). The comparison in step 450 might identify this combination as being highly similar to the normalized word “sht”, which is generated from the word “shit”. On the other hand the letter comparison in step 454 will note that there an additional letter f at the beginning of this phrase which means that the true phrase in the text is unlikely to be “shit”, but a different phrase. The additional letter will mean that path 458 is chosen and the text 120 displayed. On the other hand the potential presence of a bad phrase will than be blocked by choosing step 457.

The blocking of the word in step 440 will mean that the word is not displayed on the display. The word may be replaced by asterisks or some similar replacement rule. In this case, the user may send a message to the system administrator and ask for the word to be allowed. Alternatively the moderator can be notified of this word. This is particularly useful in the case that the word or phrase has never occurred before. It is possible, for example, that a new word or phrase has been coined relating to a TV program and that the TV program is being discussed. Because this is a newly created word, no normalized version of the word has been stored in the storage element 190 and as a result the word is not to be found on the white list as a normalized word. The moderator can analyze any such the occurrence of such words and take appropriate corrective action. This could include the addition of the word to the white list.

This aspect of the invention means that only rules for the “reduction” of words in the text 120 need to be generated in order to allow the phrase comparison (step 450) and also to take in multiple variations of the intended word. Thus the amount of manual work required by the moderator system to examine new variations of the intended word is substantially reduced, as the method automatically generates the normalized words. It will, of course, be appreciated that the normalized words are never actually displayed to the users of the system, because they would not be understandable.

Other variations to the disclosed embodiment can be understood and effected by those skilled in the art in practicing the claimed disclosure from a study of the drawings, the disclosure, and the appended claims. In the claims, the word “comprising” does not exclude other elements or steps and the indefinite article “a” or “an” does not exclude a plurality. A single unit may perform functions of several items recited in the claims and vice versa. The mere fact that certain measures are resulted in mutually different dependent claims does not mean the combinations of these measures cannot be used to advantage.

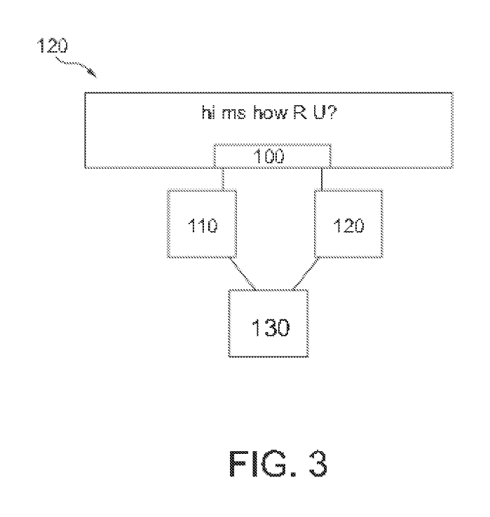

In a further aspect embodiment the present disclosure relates to an applications programming interface 400 as shown in FIG. 3. The applications programming interface 400 enables an analysis of the text 120 from the text based network mediated system 115 as previously described. The applications programming interface comprises a first interface module 410 and a second interface module 420. The first interface module 410 is adapted to for receiving the text 120 from the text based network mediated system 115. The first interface module 410 sends the text 120 to the text analyzer 130. The text 120 is analyzed by the text analyzer 130 as previously described. The second interface module 420 of the applications programming interface 400 receives the result (such as the category) and sends the result of analyzing the text 120 and the analyzed text 120 to the operator of the text based network mediated system 115.

Having thus described the present disclosure in detail, it is to be understood that the foregoing detailed description of the disclosure is not intended to limit the scope of the disclosure thereof. One of ordinary skill in the art would recognize other variants, modifications and alternatives in light of the foregoing discussion.

What is desired to be protected by letters patent is set forth in the following claims.

### REFERENCE NUMERALS

100 Apparatus
105 User
110 User device
115 Text based network mediated system
120 Text
125 Text Capturer
124 Intended word
128 Variation word
130 Text analyzer
140 Master node
150 Slave node
160 Intended word filter rule processing element
170 Blacklist word filter rule
180 Text filter
190 Storage Element
200 Method
210 Start
220 Receiving text
230 Distributing the text to the nodes
240 Analyzing the text to determine a presence of at least one variation word of an at least one intended word
250 Determining if the at least one variation word is a variation of the at least one intended word
260 Displaying or blocking the variation word to the text
270 End
310 Intended word filter rule generator.
400 Start
410 Receiving text
420 Normalize text
430 Compare text with white list
440 Block word
450 Compare Phrases
460 Display text
500 Applications programming interface
510 First interface module
520 Second interface module

1. An apparatus for analyzing text from a text based network mediated system comprising:
an at least one slave node comprising a plurality of intended word filter rule processing elements, wherein at least one slave node and a subset of the plurality of the intended word filter rule processing elements are selectable by a master node to process the at least one intended word filter rule processing elements on the text; and
a text filter.

2. The apparatus according to claim 1 further comprising a blacklist word filter rule.

3. The apparatus according to claim 1 further comprising a server comprising a storage device.

4. The apparatus according to claim 1 further comprising a clock.

5. The apparatus according to claim 1 wherein the text based network mediated system is selected from at least one of a social online network, a massively media online game network (MMOG), an instant messaging application, an ICQ based application a SMS based application or a bulletin board.

6. The apparatus according to claim 1 further comprises storage element having a corpus of normalized words.

7. A method for analyzing a text comprising:
receiving the text from a text based network mediated system,
processing the text with at least one intended word filter rule processing element,
analyzing the text to determine a presence of at least one variation word of an at least one intended word,
determining if the at least one variation word is a variation of the at least one intended word; and
one of displaying or blocking the variation word to the text to the text based network mediated system, or
reporting that the variation word is a variation of the at least one intended word.

8. The method according to claim 7, wherein the at least one variation word is at least one of an expression of the at least one intended word devoid of at least one vowel, a misspelling of the at least one intended word, a phonetic replacement of the at least one intended word, a pluralization of the at least one intended word, an alliteration of the at least one intended word or a colloquial expression of the at least one intended word.

9. The method according to claim 7 further comprising storing a result that the at least one variation word is a variation of the at least one intended word.

10. The method according to claim 7 further comprising analyzing the text with a blacklist word filter rule.

11. The method according to claim 7 further comprising analyzing the text in one of real time or delayed time.

12. The method according to claim 7 further comprising analyzing the text when present on at least one of a user device or a text based network mediated system.

13. The method according to claim 7, wherein the analyzing the text comprises normalizing at least one of the words in the text to generate the at least one intended word.

14. An at least one intended word filter rule processing element adapted to analyze a text, present on a text based network mediated system, the at least one intended word filter rule processing element comprising a plurality of variation words of an intended word, wherein the plurality of variation words is at least one of an expression of the intended word devoid of at least one vowel, a misspelling of the intended word, a phonetic replacement of the intended word, a pluralization of the intended word, an alliteration of the intended word or a colloquial expression of the intended word.

15. A method for creating at least one intended word filter rule processing element comprising:
providing at least one intended word,
creating a plurality of variation words of the at least one intended word, wherein the plurality of variation words is at least one of an expression of the at least one intended word devoid of at least one vowel, a misspelling of the at least one intended word, a phonetic replacement of the at least one intended word, a pluralization of the at least intended word, an alliteration of the at least one intended word or a colloquial expression of the at least one intended word.

16. A computer program product comprising a computer usable medium having control logic stored therein for causing a computer to analyze a text from a text based network mediated system, the control logic comprising:
a first computer readable program code means for causing the computer to receive the text,
a second computer readable program code means for causing the computer to process the text with at least one intended word filter rule processing element,
a third computer readable program code means for causing the computer to analyze the text to determine a presence of at least one variation word of an at least one intended word,
a fourth computer readable program means for causing the computer to determine if the at least one variation word is indicative of the at least one intended word; and
a fifth computer readable program code means for causing the computer to one of displaying or blocking the variation word that is a variation of the at least one intended word to the text.

17. An applications programming interface for analyzing text from a text based network mediated system comprising:
a first interface module for receiving the text from the text based network mediated system and sending the text to a text analyzer, wherein the text analyzer is adapted to analyze the text to determine a presence of an at least one variation word of an at least one intended word in the text and to produce a result of analyzing the text; and
a second interface module for sending the result of analyzing the text and the analyzed text to the text based network mediated system.
